(19) United States
(12) Patent Application Publication
(10) Pub. No.: US 2025/0392998 A1
(43) Pub. Date: Dec. 25, 2025

(54) SYNCHRONIZATION MANAGEMENT METHOD AND SYSTEM

(71) Applicant: T-Mobile Innovations LLC, Overland Park, KS (US)

(72) Inventors: Rahul AMIN, Issaquah, WA (US); Saravana VELUSAMY, Overland Park, KS (US)

(21) Appl. No.: 18/751,801

(22) Filed: Jun. 24, 2024

(51) Int. Cl. H04W 56/00

(52) U.S. Cl. CPC H04W 56/001

(57) ABSTRACT

Methods and systems provided herein manage synchronization between an session management function (SMF) and multiple user plane functions (UPFs). The method includes concatenating, at a session management function (SMF), Internet protocol (IP) chunks assigned to a corresponding UPF to create a concatenated IP chunks string. The method further includes applying a hashing algorithm to the concatenated IP chunks string to create a digest including a hash value. The method additionally includes receiving, from the corresponding UPF, a UPF created digest table maintained by the corresponding UPF. The method further includes comparing the UPF created digest table maintained by the corresponding UPF with the hash value created by the SMF for the corresponding UPF and determining whether the corresponding UPF is synchronized with the SMF based on the comparison.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

5G networks include a core network utilizing a service based architecture (SBA) and further follow the separation of control plane and user plane functionalities (CUPS). The 5G core network includes a session management function (SMF) that performs control plane functionality as well as internet protocol address management (IPAM) functionality. IPAM provides a method of tracking and managing IP addresses of a network. In order to implement IPAM functionality, the SMF divides a large IP-pool into small IP chunks, and gradually assigns and also withdraws these IP chunks to or from user plane function (UPF) peers depending on assigned IP chunks utilization for specific UPFs. At times, due to network disruptions, such as failovers, switchovers, SMF or UPF upgrades, etc., the SMF and UPF may become out-of-sync, which causes session attach failures, reverse routing, and other types of issues that degrade performance and negatively impact customer experience. Accordingly, a solution is needed for overcoming problems associated with lack of synchronization between the UPFs and the SMF during IPAM processing.

### OVERVIEW

Exemplary embodiments provided herein include a method for detecting synchronization issues between a session management function (SMF) and a user plane function (UPF) during the internet protocol address management (IPAM) process. A method includes concatenating, at an SMF, Internet protocol (IP) chunks assigned to a corresponding user plane function (UPF) out of multiple UPFs to create a concatenated IP chunks string. The method further includes applying a hashing algorithm to the concatenated IP chunks string. The method further includes maintaining an IP chunks digest table by the SMF for the corresponding UPF. Additionally, the method includes receiving, from the corresponding UPF, a UPF created digest table maintained by the corresponding UPF and comparing the UPF created digest table maintained by the corresponding UPF with the IP chunks digest table created by the SMF for the corresponding UPF. The method further includes determining whether the corresponding UPF is synchronized with the SMF based on the comparison.

In a further embodiment, a system is provided including a memory storing instructions and an IP chunks digest table maintained by a session management function (SMF) for a corresponding user plane function (UPF). The system additionally includes a processor executing the stored instructions to perform multiple operations. The operations include assigning an IP chunk to the corresponding user UPF and concatenating and hashing IP chunks assigned to the corresponding UPF upon transmission of an IP chunk to the corresponding UPF to maintain the IP chunks digest table for the corresponding UPF. The operations additionally include receiving, from the corresponding UPF, a UPF created digest table maintained by the corresponding UPF and comparing the UPF created digest table maintained by the corresponding UPF with the IP chunks digest table maintained by the SMF for the corresponding UPF. The operations further include determining whether the corresponding UPF is synchronized with the SMF based on the comparison.

Additional embodiments include a method performed at a UPF. The method includes receiving at a UPF an IP chunk from an SMF and concatenating and hashing the IP chunk with other assigned IP chunks. The method further includes updating a UPF IP chunks digest table at the UPF based on the concatenating and hashing and providing the updated UPF IP chunks digest table in a message to the SMF.

### BRIEF DESCRIPTION OF THE DRAWINGS

FIG. 1 depicts an exemplary environment for a synchronization management system in accordance with an embodiment.

FIG. 2 depicts a synchronization management system in accordance with an embodiment.

FIG. 3 depicts a synchronization management system operating within a core network in accordance with an embodiment.

FIG. 4 depicts an exemplary method for synchronization management performed at an SMF in a network in accordance with an embodiment.

FIG. 5 depicts a further exemplary method for synchronization management performed at an SMF in accordance with an embodiment.

FIG. 6 depicts an exemplary method for synchronization performed at a UPF in accordance with an embodiment.

FIG. 7 depicts an additional exemplary method for synchronization performed at a UPF in accordance with an embodiment.

FIG. 8 is a diagram illustrating operation of the synchronization management system in accordance with an embodiment.

### DETAILED DESCRIPTION

In embodiments disclosed herein, a synchronization management system identifies whether a session management function (SMF) and user plane functions (UPFs) are synchronized during internet protocol address management (IPAM) processing. Embodiments disclosed herein concatenate and hash IP chunks to generate a digest and use the generated digest to identify whether UPFs are in-sync or out-of-of sync with the SMF. Systems and methods described herein take corrective action in order to remove out-of-sync UPFs from IPAM processing.

Each SMF typically connects with multiple UPFs over an N4 interface. Accordingly, embodiments described herein are implemented to hash IP chunks to generate a digest at both the SMF and the UPF. The generated digests from the UPF are communicated in specific N4 call flow procedures to the SMF so the SMF can compare the digests to determine if each UPF is in-sync or out-of-sync with the SMF. Further, embodiments provided herein implement corrective actions when the digest from the SMF does not match the transmitted digest from the UPFs and are thus deemed out-of-sync. The corrective actions may include, for example, removing the out-of-sync UPF from the IPAM process, thereby prohibiting the UPF from having N4 interactions with the SMF and further generating an alarm when an out-of-sync UPF is identified.

Further, the SMF typically peers with multiple UPFs, and assigns and withdraws IP chunks to and from each UPF. In methods disclosed herein, while assigning IP chunks, the SMF concatenates and hashes all the IP chunks assigned to each corresponding UPF to generate a digest and stores the digest in an SMF IP chunks digest table. Upon receiving an IP chunk, the UPF will also concatenate the new IP chunk with pre-existing chunks to generate a concatenated IP chunk string and perform a hash on the concatenated IP chunk string to generate a new digest. The UPF will then update its UPF IP chunks digest table by incorporating the new digest.

Embodiments described herein will cause the UPF to provide this updated digest to the SMF in messages through the N4 interface. The messages include, for example, packet forwarding control protocol (PFCP) association update and PFCP association heartbeat messages. Upon receiving the message from the UPF, methods disclosed herein cause the SMF to compare the received digest value with the value for the corresponding UPF stored in the SMF IP chunks table for the corresponding specific UPF. If the digest values match, then the SMF and the corresponding UPF are synchronized. However if the values do not match, then embodiments described herein will cause the SMF to mark this corresponding UPF as out-of-synchronization and will take corrective action to ensure the corresponding UPF remains offline and further may cause an alarm to be generated. Putting the UPF offline ends its N4 interaction with the SMF and prohibits the UPF from receiving or surrendering IP chunks until corrective action is taken.

In addition to the systems and methods described herein, non-transitory computer-readable mediums may store the operations for the instructions or methods. Further, processing nodes on the network may execute the instructions or methods. The processing node may include a processor included in the SMF and/or UPF or a processor included in any controller node in the wireless network.

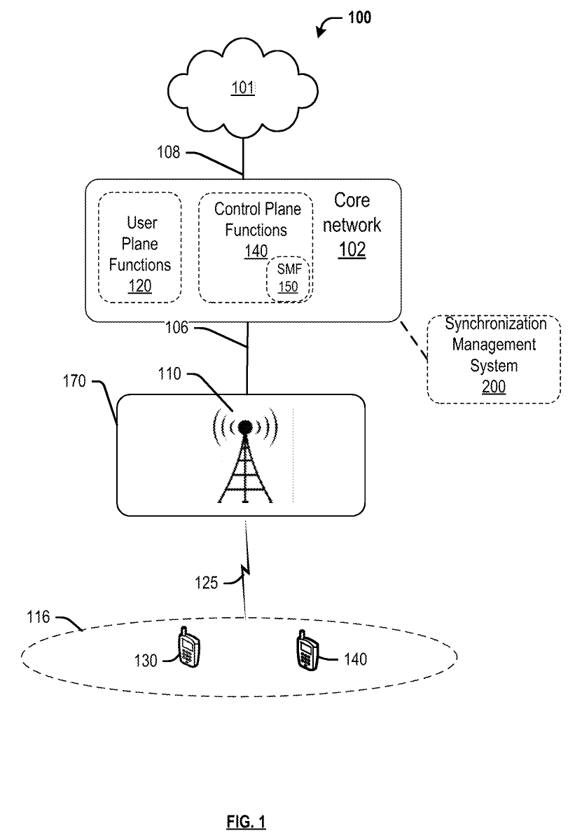

FIG. 1 depicts an exemplary environment 100 for implementing a synchronization management system 200. Environment 100 comprises a communication network 101, core network 102, and a radio access network (RAN) 170 including at least an access node 110. Wireless devices 130 and 134 located in a coverage area 116 communicate with the access node 110 over communication link 125. Further, the synchronization management system 200 interacts with the core network 102 to monitor synchronization between UPFs 120 and control plane functions 140, more specifically the SMF 150. Furthermore, components not shown may include, for example, gateway node(s) controller nodes, and additional access nodes.

The synchronization management system 200 is illustrated as communicating with or incorporated in the core network 102. The core network 102 may have an evolved packet core (EPC) structure or be structured using a service based architecture (SBA) utilizing core network functions and elements including user plane functions (UPFs) 120 and control plane functions 140. The control plane functions 140 include at least a session management function (SMF) 150 and may further include the additional components described herein. In an SBA architecture, service-based interfaces may be utilized between control plane functions 140, while UPFs 120 connect over point-to-point link. The user plane function (UPF) 120 accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and the SMF 150. Additional or fewer control plane functions may also be included. The AMF receives connection and session related information from the wireless devices 130 and 134 and is responsible for handling connection and mobility management tasks. The SMF 150 is primarily responsible for creating, updating and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

The RAN 170 can include various access network functions and devices disposed between the core network 102 and the end-user wireless devices 130, 134. For example, the RAN 170 includes at least an access node (or base station), such as an eNodeB and/or a next generation NodeB (gNodeB) 110 communicating with a plurality of end-user wireless devices 130, 134. Further, either of core network 102 and radio access network 170 can include one or more of a local area network, a wide area network, and an internetwork (including the Internet) and capable of communicating signals and carrying data, for example, to support voice, push-to-talk, broadcast video, and data communications by end-user wireless devices 130, 134.

Access node 110 can be any network node configured to provide communication between end-user wireless devices 130 and 134 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 130 and 134 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless devices 130 and 134 may be any device, system, combination of devices, or other such communication platform capable of communicating wirelessly with access node 110 using one or more frequency bands deployed therefrom. Wireless devices 130 and 134 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. As set forth above, the wireless devices 130 and 134 may utilize different applications at different times, which may cause them to be assigned to different network slices. The wireless devices 130, 134 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 130, 134, etc. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path - including combinations thereof. Communication link 106 can be wired or wireless and use various communication protocols such as Internet, Internet protocol (IP), local-area network (LAN), optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

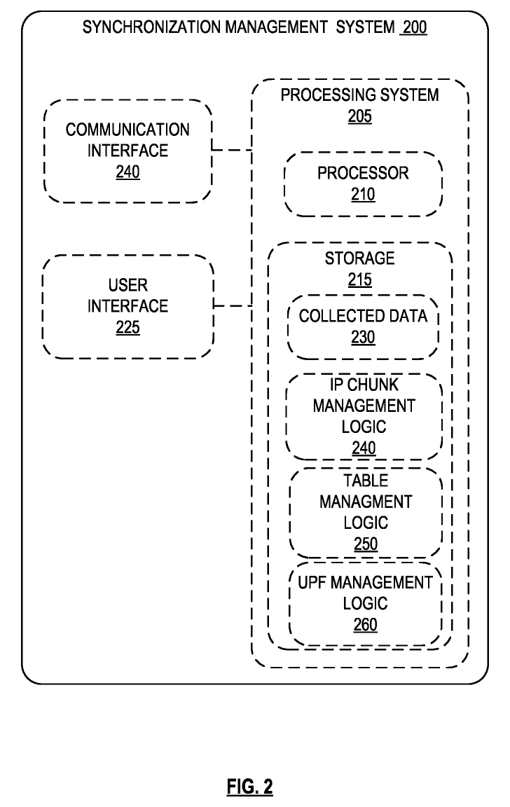

FIG. 2 illustrates a synchronization management system 200 in accordance with embodiments described herein. The components described herein are merely exemplary as many different configurations for the synchronization management systems 200 may be implemented. The synchronization management system 200 may be configured to perform the methods and operations disclosed herein to dynamically determine whether corresponding UPFs 120 are synchronized with an SMF 150 and take corrective action with respect to out-of-sync UPFs 120. In the disclosed embodiments, the synchronization management system 200 may be integrated with the core network 102 or may be an entirely separate component capable of communicating with at least the SMF and UPF of the core network. Further, the components of the synchronization management system 200 may be distributed so that one or more components are located within the SMF 150, a UPF 120, and/or a separate processing node in communication with or integrated with the core network 102.

The synchronization management system 200 may be configured for performing the operations described herein during IPAM processing in order determine whether corresponding UPFs 120 are synchronized with the SMF 150 and to take corrective action when a UPF 120 is out-of-sync with the SMF 150 utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, IP chunk management logic 240 may cause the SMF 150 to transmit and to withdraw IP chunks from corresponding UPFs 120. Table management logic 250 may be utilized to cause the SMF and UPF to each concatenate and hash IP chunks to generate a corresponding digest and to respectively store each corresponding digest in one of an SMF IP chunks table and a UPF IP chunks table. Further, UPF management logic 260 may trigger the SMF to compare digests from stored tables, determine whether a UPF 120 is out-of-sync with the SMF 150, and take corrective action when the UPF 120 is out-of-sync with the SMF 150. Further, the memory 215 may store the collected data at 230, which may be or include IP chunks tables storing the generated digests described above. To perform the above-described operations, the IP chunk management logic 240, the table management logic 250 and the UPF management logic 260 may be executed by the processor 210 to operate on the collected data 230 to manage UPF 120 and SMF 150 synchronization.

Processor 210 may be a microprocessor and may include hardware circuitry and/or embedded codes configured to retrieve and execute software stored in storage device 215. The synchronization management system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the synchronization management system 200 and receive data or information from other system components. User interface 225 may include hardware components, such as touch screens, buttons, displays, speakers, etc. The synchronization management system 200 may further include other components such as a power management unit, a control interface unit, etc.

The location of the synchronization management system 200 may depend upon the network architecture. As set forth above, the synchronization management system 200 may be located in the core network , in a separate processing node, , in multiple locations such as the SMF 150 and UPFs 120, or may be an entirely discrete component. Further, although shown as a single integrated system, the functions of data collection, IP chunk management, table management logic, and UPF management logic may be separated and disposed in separate locations.

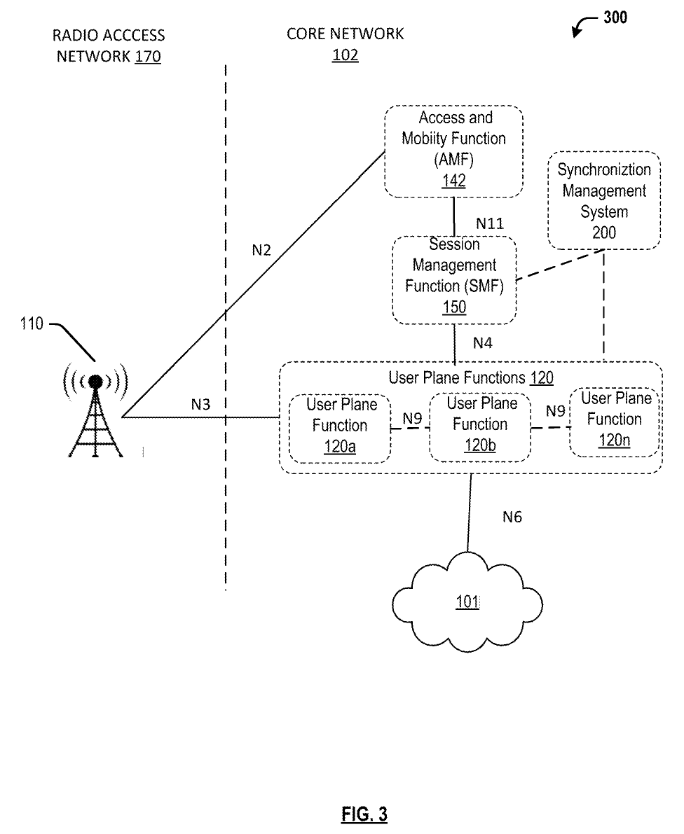

FIG. 3 depicts an environment 300 showing a synchronization management system 200operating within a core network 102 in accordance with an embodiment. Further, FIG. 3 illustrates control and user plane separation (CUPS). The access node 110, within the RAN 170 communicates with components within the core network 102. The access node 110 communicates with the control plane components over an N2 interface and user plane components over an N3 interface within the user plane. The UPFs 120 include UPFs 120a, 120b..120n. Within the control plane, AMF 142 and SMF 150 are illustrated. The synchronization management system 200 interacts with both the control and user planes within the core network 102.

Thus, data packets associated with data sessions, e.g. payload, etc., traverse the user plane over the N3 interface, while data packets associated with control signals (to manage the data sessions) are transmitted via the N2 interface. For example, an access and mobility function (AMF) 142 can receive connection requests from one or more wireless devices via access node 110, and manage tasks associated with connection or mobility management, while forwarding session management requirements over an N11 interface to a session management function (SMF) 150. Meanwhile, the SMF 150 is primarily responsible for interacting with the UPFs120, creating updating and removing Protocol Data Unit (PDU) sessions and managing session context with UPFs 120 over the N4 interface.

UPFs 120a..120n and SMFs can include a processor, a memory, and may be configured to perform the various functions described herein Further, each UPF 120 can associate with different reference points, including reference points for data transmission between different network nodes and reference points for control signal transmission between different network nodes. This can include the N3 reference point, which for example is used as a data input or output between the UPF 120 and access node 110. Further, the N6 reference point is used as a data input or output between the UPFs 120 and one or more packet data networks (PDNs) 101. Further, the N9 reference point is used as a data input or output between UPFs 120a…120n. Further, a control signal reference point, such as the N4 reference point, is used as an input for control signals from the SMF 150. For example, as described herein, UPF 120a..120n receive session information from SMF 150, via N4 reference point. The control information received via the N4 reference point includes information related to IPAM processing and may further include additional information such as for provisioning a new session using the packet forwarding control protocol (PFCP), quality of service information, billing information (including how and when to generate billing records), unique identifiers for a session, and so on.

Further, the synchronization management system 200 may operate as a processing node in communication with the UPFs 120 and the SMF 150. Alternatively, the synchronization management system 200 may be partially or wholly incorporated in the SMF 150 and/or the UPFs 120 in order to trigger the SMF 150 and the UPFs 120 to perform the methods described herein in order to identify and manage UPFs that are out-of-sync with the SMF 150.

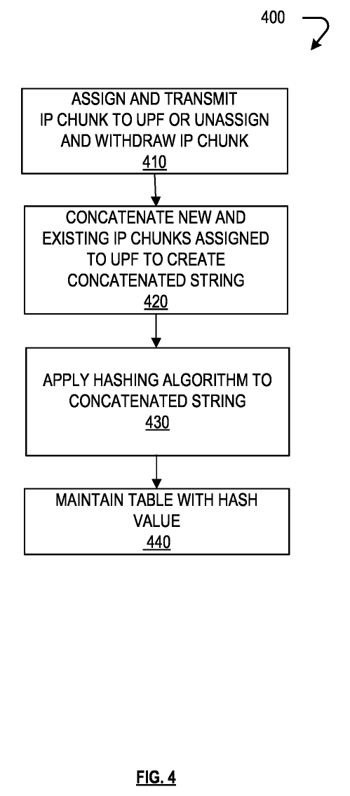

FIG. 4 illustrates an exemplary method 400 for synchronization management between the SMF 150 and multiple UPFs 120 in a network. Method 400 may be performed by any suitable processor discussed herein, for example, a processor 210 included in a synchronization system, or a processor in an SMF 150. For discussion purposes, as an example, method 400 is described as being performed by the processor 210 of the synchronization management system 200. However, it should be understood that the steps illustrated in FIG. 4 are performed in conjunction with the SMF 150.

Method 400 starts in step 410, in which the processor 210 triggers the assignment and transmission of IP chunks to the UPF 120 by the SMF 150. Alternatively, step 410 may include the reverse process of unassigning and withdrawing an IP chunk from the UPF 120.

In step 420, the processor 210 concatenates existing IP chunks for each UPF to create a concatenated string. For example, the processor 210 may concatenate IP chunks (1) 2.1.0.0/24 and (2) 2.2.0.0/24 to create the concatenated IP chunks string 210024220024.

In step 430, the processor 210 applies a hashing algorithm to the concatenated IP chunks string described above for the corresponding UPF 120 in order to create a digest. Thus, the processor 210 concatenates and hashes existing IP chunks with the additional assigned IP chunk for the corresponding UPF 120 when a new IP chunk is transmitted. Alternatively, the processor 210 concatenates and hashes the remaining IP chunks after removal of an IP chunk when the processor 210 causes an IP chunk to be unassigned or withdrawn from the corresponding UPF 120.

Finally in step 440, the processor 210 adds the digest to the SMF IP chunks table to maintain the SMF IP chunks table. The SMF IP chunks table may include digests for multiple UPFs 120.

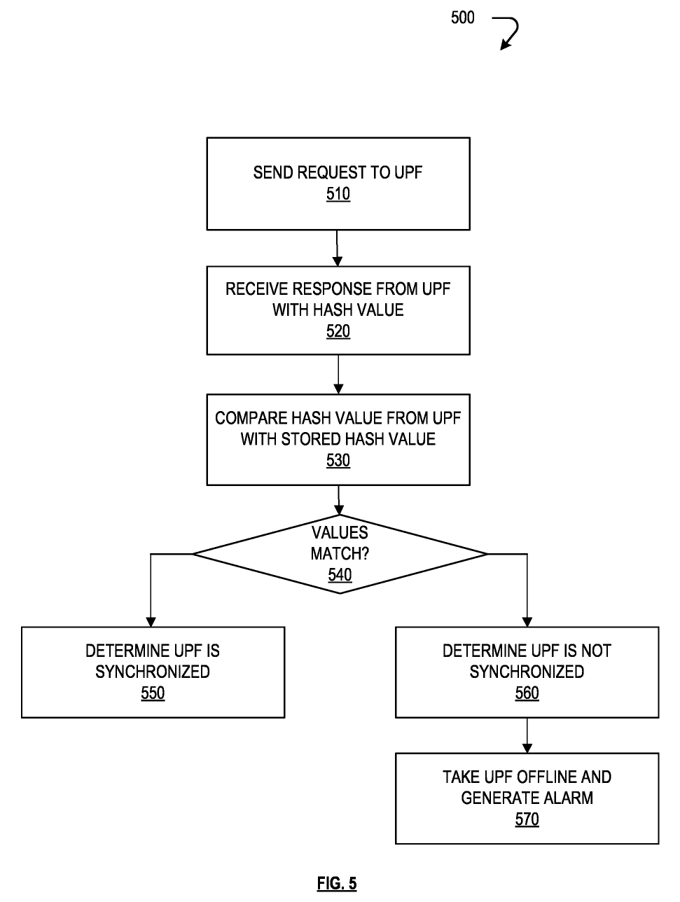

FIG. 5 depicts an exemplary method 500 for synchronization management in accordance with an embodiment. Method 500 may be performed by any suitable processor discussed herein, for example, a processor included in the synchronization management system 200 or in the SMF 150. For discussion purposes, as an example, method 500 is described as being performed by the processor 210 included in the synchronization management system 200, which may be wholly or partially incorporated in the SMF 150.

Method 500 starts in step 510, in which the processor 210 causes a request to be sent from the SMF 150 to the UPF 120. The request may be or include, for example, an N4 request, such as a PFCP association heartbeat request or a PFCP association update request. In step 520, the processor 210 receives a response from the a corresponding UPF 120 with a digest including a hash value. As will be further explained below, this digest transmitted from the UPF 120 is also formulated by the UPF 120.

In step 530, the processor 210 compares the hash value received from the UPF 120 with a stored hash value in the SMF IP chunks table for the corresponding UPF. For example, the SMF IP chunks table stores digests for multiple UPFs, but compares the received hash value with the hash value in the IP chunks table for the corresponding UPF.

If the hash values match in step 540, the processor 210 determines in step 550 that the corresponding UPF 120 is synchronized or in-sync with the SMF 150. In this instance, the processor 210 takes no further action with respect to the UPF 120. However, if the hash values do not match in step 540, the processor 210 determines in step 560 that the corresponding UPF 120 is not synchronized or is out-of-sync with the SMF 150.

Finally, in step 570, upon discovering that the UPF 120 is out-of-sync with the SMF 150, the processor 210 takes the UPF 120 offline. Further, the processor 210 may generate an alarm so that further action may be taken. Accordingly, the out-of-sync UPF 120 will not receive further IP chunks or additional N4 messages until the synchronization problem is resolved. The synchronization problem is typically due to network disruptions and can be corrected by refreshing the UPF 120 with a current state reflected in the SMF IP chunks table.

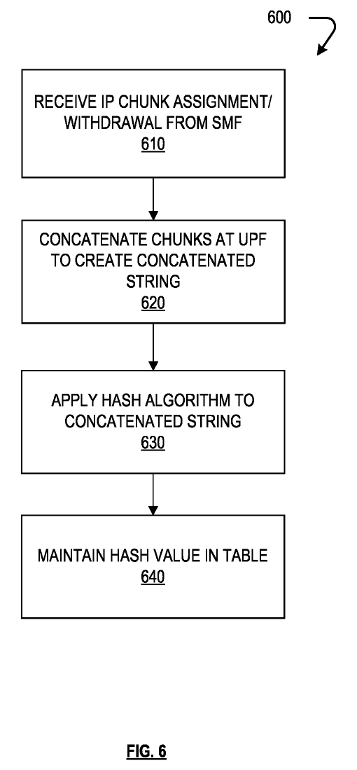

FIG. 6 depicts an additional exemplary method 600 for synchronization management in accordance with an embodiment. Method 600 may be performed by any suitable processor discussed herein, for example, a processor in the UPF 120 or the processor 210 included in the synchronization management system 200, which may be wholly or partially incorporated in the UPF 120. For discussion purposes, as an example, method 600 is described as being performed by the processor 210 included in the synchronization management system 200.

In step 610, the processor 210 cause an IP chunk assignment or an IP chunk withdrawal to be received at the UPF 120 from the SMF 150, for example, in a PFCP association update request. In response to the IP chunk assignment or withdrawal in step 610, the processor 210 may cause computation of a new concatenated IP chunks string based on the assigned or withdrawn IP chunk in step 620. Accordingly, if the original IP chunks string was 210024220024 and a new IP chunk (3) 2.3.0.0/27 was added, the new concatenated string is 210024220024230027.

Accordingly, in step 630, the processor 210 causes a hashing algorithm to be applied to the new concatenated string. The application of the hashing algorithm in step 630 causes a new hash value to be generated. Thus, in step 640, the processor 210 causes the new hash value to be maintained in a digest in a UPF IP chunks table at the UPF 120. Thus, the hash value computed in step 630 can be utilized for comparison to the hash value in the SMF IP chunks table to determine synchronization status as described above.

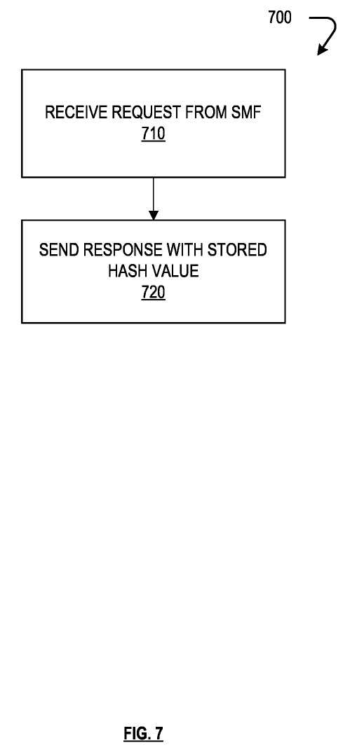

FIG. 7 depicts an additional exemplary method 700 for synchronization management. Method 700 may be performed by any suitable processor discussed herein, for example, a processor 210 included in the synchronization management system 200, which may be wholly or partially incorporated in the UPF 120. For discussion purposes, as an example, method 700 is described as being performed by the processor 210.

In step 710, the processor 210 receives an N4 request from the SMF 150 requesting a response. The request may be or include, for example, a PFCP association heartbeat request or a PFCP association update request. In step 720, the processor 210 causes the UPF 120 to send a response with the currently stored hash value. The response may be, for example, a PFCP association heartbeat response or a PFCP association update response. The sending of this response enables comparison of hash values in the SMF IP chunks table to the hash value transmitted in step 720 in order to determine whether the UPF 120 is synchronized with the SMF 150.

Accordingly, as set forth above, embodiments provide for synchronization management in order to ensure that UPFs 120 are synchronized with SMF 150. UPFs 120 that are found to be out-of-sync are taken offline until corrective action can be taken. An alarm can be generated to ensure that system components appropriately respond to generate corrective action.

In some embodiments, methods 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, and 700 may be integrated in any useful manner.

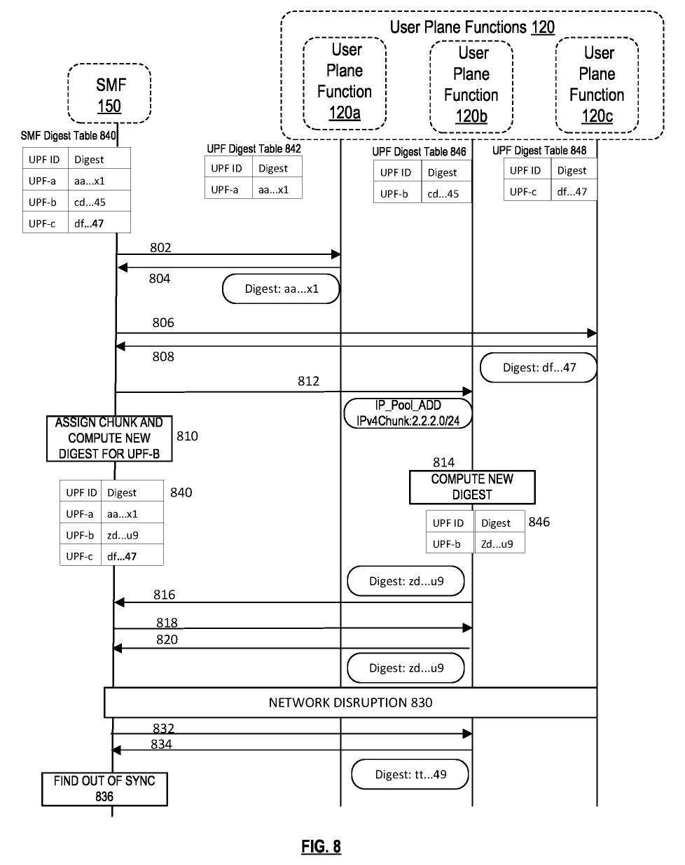

FIG. 8 is a diagram illustrating operation of the synchronization management system 200 in accordance with an embodiment. As explained above, the synchronization management system 200 may be partially or wholly incorporated in the SMF 150 and/or UPF 120. FIG. 8 illustrates interaction between the SMF 150 the UPFs 120, including UPF 120a, UPF 120b, and UPF 120c. As illustrated, the SMF 150 maintains an SMF IP chunks digest table 840, which stores a digest including hash values for the multiple UPFs 120a, 120b, and 120c at any given time. Similarly, the UPFs 120 also store and maintain digest tables. UPF 120a maintains a digest table 842. UPF 120b maintains a digest table 846. UPF 120c maintains a digest table 848.

The SMF IP chunks digest table 840 is formulated based on assignment of IP chunks. For example, the SMF 150 may assign two IP chunks such as (1) 2.1.0.0/24; and (2) 2.2.0.0/24 to a UPF 120b As described above, the SMF 150 calculates a concatenated IP chunks string: “210024220024”. Further, the SMF 150 applies a hashing algorithm to the concatenated IP chunks string to compute a corresponding digest value as shown in the digest table 840. The hashing algorithm may then produce, for example, the digest cd…45 for the UPF 120b.

In the illustrated scenario, in a first request, the SMF 150 sends a PFCP association heartbeat request to the UPF 120a. In response, the UPF 120a sends a PFCP association heartbeat response at 804 accompanied by the digest stored in the UPF digest table 842. Ass illustrated, the digest includes the hash value aa…x1, which corresponds to the value stored in the SMF IP chunks digest table 840 for the UPF 120a.

In step 806, the SMF 150 sends a PFCP association heartbeat request to UPF 120c. In response, at 808, the UPF 120c sends its digest containing the value df…47 back to the SMF 150. As illustrated, this corresponds to the value in the SMF IP chunks digest table 840 for UPF 120c.

In step 810, the SMF 150 assigns an IP chunk to UPF 120b and computes a new digest for UPF 120b. For example, the SMF 150 may assign a new IP chunk 2.3.0.0/27. Thus, the resulting concatenated IP chunks string is 210024220024230027. The SMF 150 then applies the hashing algorithm to this concatenated IP chunks string to compute the digest value, which is shown as zd…u9, which replaces the previously stored value of cd…45.

In step 812, the SMF 150 sends a PFCP association update request to UPF 120b. The update request includes transmission of the IP chunk. Thus, at 814, the UPF 120b computes a new digest concatenating all existing IP chunks and performing a hash, as described above with respect to step 810. The updated digest 846 includes the hash value zd…ud. The UPF 120b then returns at 816 the newly computed digest to the SMF 816. In step 818, the SMF 150 sends a PFCP association heartbeat request to the UPF 120b and the UPF 120b returns the digest in step 820.

At 830, a network disruption occurs. The network disruption may result in communication errors, which cause the UPFs 120 to become out-of-sync with the SMF 150. Accordingly, after the network disruption, when the SMF 150 sends a PFCP association heartbeat request in in step 832 to the UPF 120b, the UPF 120b may send a digest in step 834 that does not correspond to the digest stored in the SMF IP chunks table 830. Accordingly, the SMF 150 finds the UPF 120b to be out-of-sync at 836.

Although the above steps show the addition of an IP chunk, the same process is followed upon withdrawal of an IP chunk, i.e., when the SMF 150 withdraws an IP chunk from any of UPFs 120a, 120b, 120c. For example, if the SMF 150 withdraws the IP chunk 2.2.0.0/24 from UPF 120b, it removes the IP chunk from the existing concatenated IP chunk string: 210024230027. The SMF 150 then applies the hashing algorithm on the concatenated IP chunks string to compute a new digest value. The hash is computed separately by the SMFs 150 and the UPFs 120 whenever the concatenated IP chunk string changes. The change in the concatenated IP chunks string can result from either adding or withdrawing IP chunks from any of the UPFs 120.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
concatenating, at a session management function (SMF), Internet protocol (IP) chunks assigned to a corresponding user plane function (UPF) out of multiple UPFs to create a concatenated IP chunks string;
applying a hashing algorithm to the concatenated IP chunks string to create a digest including a hash value;
maintaining an IP chunks digest table including the digest by the SMF for the corresponding UPF;
receiving, from the corresponding UPF, a UPF created digest table maintained by the corresponding UPF;
comparing the UPF created digest table maintained by the corresponding UPF with the IP chunks digest table created by the SMF for the corresponding UPF; and
determining whether the corresponding UPF is synchronized with the SMF based on the comparison.

2. The method of claim 1, further comprising concatenating and applying the hashing algorithm upon transmission of an IP chunk from the SMF to the corresponding UPF.

3. The method of claim 1, further comprising identifying the corresponding UPF as synchronized with the SMF when the UPF created digested table matches the IP chunks table created by the SMF.

4. The method of claim 1, further comprising identifying the corresponding UPF as out of synchronization with the SMF when the UPF created digested table does not match the IP chunks table created by the SMF.

5. The method of claim 4, further comprising identifying the corresponding UPF as out of synchronization with the SMF upon experiencing a network disruption.

6. The method of claim 4, further comprising prohibiting the corresponding UPF from receiving IP chunks upon identification of the corresponding UPF as out of synchronization.

7. The method of claim 4, further comprising generating an alarm upon identifying the corresponding UPF as out of synchronization.

8. The method of claim 1, further comprising receiving the UPF created digest table at the SMF with a packet forwarding control protocol (PFCP) association heartbeat response.

9. The method of claim 1, further comprising transmitting the IP chunk from the SMF to the corresponding UPF with a packet forwarding control protocol (PFCP) association update request.

10. The method of claim 9, further comprising receiving the UPF created digest table with a PFCP association update response.

11. A system comprising:
a memory storing instructions and an IP chunks digest table maintained by a session management function (SMF) for a corresponding user plane function (UPF);
a processor executing the stored instructions to perform operations comprising:
concatenating and hashing IP chunks assigned to the corresponding UPF upon transmission of the IP chunk to the corresponding UPF to maintain the IP chunks digest table for the corresponding UPF;
receiving, from the corresponding UPF, a UPF created digest table maintained by the corresponding UPF;
comparing the UPF created digest table maintained by the corresponding UPF with the IP chunks digest table maintained by the SMF for the corresponding UPF; and
determining whether the corresponding UPF is synchronized with the SMF based on the comparison.

12. The system of claim 11, the operations further comprising identifying the corresponding UPF as synchronized with the SMF when the UPF created digested table matches the IP chunks table maintained by the SMF.

13. The system of claim 11, the operations further comprising identifying the corresponding UPF as out of synchronization with the SMF when the UPF created digested table does not match the IP chunks table maintained by the SMF.

14. The system of claim 13, the operations further comprising identifying the corresponding UPF as out of synchronization with the SMF upon experiencing a network disruption.

15. The system of claim 13, the operations further comprising prohibiting the corresponding UPF from receiving IP chunks upon identification of the corresponding UPF as out of synchronization with the SMF.

16. The system of claim 13, the operations further comprising generating an alarm upon identifying the corresponding UPF as out of synchronization with the SMF.

17. The system of claim 13, the operations further comprising assigning an IP chunk to the corresponding user UPF prior to the concatenating and the hashing of the IP chunks.

18. A method comprising:
receiving at a user plane function (UPF) an internet protocol (IP) chunk from a session management function (SMF);
concatenating and hashing the IP chunk with other assigned IP chunks;
updating a UPF IP chunks digest table at the UPF based on the concatenating and hashing; and
providing the updated UPF IP chunks digest table in a message to the SMF.

19. The method of claim 17, further comprising providing the updated IP chunks digest table in an N4 message.

20. The method of claim 18, wherein the N4 message is a packet forwarding control protocol (PCFP) association update response message or a packet forwarding control protocol (PCFP) association heartbeat response message.
